(19) United States
(12) Patent Application Publication
(10) Pub. No.: US 2026/0202610 A1
(43) Pub. Date: Jul. 16, 2026

(54) SEMICONDUCTOR STRUCTURE AND METHOD FOR FORMING THE SAME

(71) Applicant: Taiwan Semiconductor Manufacturing Company, Ltd., Hsinchu (TW)

(72) Inventor: Shenggao LI, Hsinchu (TW)

(73) Assignee: Taiwan Semiconductor Manufacturing Company, Ltd., Hsinchu (TW)

(21) Appl. No.: 19/024,534

(22) Filed: Jan. 16, 2025

(51) Int. Cl. G02B 6/12; G02B 6/13

(52) U.S. Cl. CPC G02B 6/12004; G02B 6/13

(57) ABSTRACT

A semiconductor structure is provided, which includes a substrate and a waveguide layer formed on the substrate. The waveguide layer includes a plurality of waveguides. The semiconductor structure further includes a plurality of processing dies arranged in an array on the waveguide layer, and a plurality of electric integrated circuit (EIC) dies arranged at a periphery of the array on the waveguide layer and electrically coupled with the plurality of processing dies. At least two of the plurality of EIC dies arranged at opposite edges of the array are coupled to each other through a corresponding waveguide of the plurality of waveguides.

### BACKGROUND

As electronic systems and integrated circuits continue to evolve, the need for high-efficiency, low-latency communication networks within system on wafer (SoW) and fan-out panel level packaging (FOPLP) has increased, especially in the fields of high-performance computing (HPC) and data-intensive applications. Conventional network topologies, such as mesh and ring configurations, have limitations in larger systems where an increase in the quantity of processing dies reduces communication efficiency.

One enabling technology is an interconnect structure with torus network topology designed to form an efficient, scalable interconnect with minimal overhead. However, as the quantity of the processing dies further increases, the interconnect structure with torus network topology still poses many challenges, such as communication efficiency, latency, and high insertion loss associated with electrical wiring over extended distances. As such, advances in the field of interconnect structure for torus network topology are necessary to reduce latency and insertion loss, and further improvements in communication efficiency are needed in order to meet the desired design criteria such that the march towards smaller and smaller components may be maintained.

### BRIEF DESCRIPTION OF THE DRAWINGS

The present disclosure is best understood from the following detailed description when read with the accompanying figures. It is emphasized that, in accordance with the standard practice in the industry, various features are not drawn to scale and are used for illustration purposes only. In fact, the dimensions of the various features may be arbitrarily increased or reduced for clarity of discussion.

FIG. 1A shows a schematic top view of a semiconductor structure, according to embodiments of the disclosure.

FIG. 1B shows a schematic cross-sectional view of the semiconductor structure in FIG. 1A, according to embodiments of the disclosure.

FIG. 1C shows a schematic cross-sectional view of the semiconductor structure in FIG. 1A, according to embodiments of the disclosure.

FIG. 2 shows a schematic top view of the plurality of waveguides, according to embodiments of the disclosure.

FIG. 3 shows a schematic cross-sectional view of the semiconductor structure in FIG. 1A, according to embodiments of the disclosure.

FIG. 4 shows a schematic cross-sectional view of the semiconductor structure in FIG. 1A, according to embodiments of the disclosure.

FIG. 5 shows a schematic top view of the plurality of waveguides, according to embodiments of the disclosure.

FIG. 6 shows a schematic cross-sectional view of a portion of the semiconductor structure, according to embodiments of the disclosure.

FIG. 7 illustrates a process flow of manufacturing a semiconductor structure, according to embodiments of the disclosure.

FIGS. 8, 9, 10, 11, 12, 13, 14, 15A, 15B, 16, and 17 show schematic cross-sectional views of process stages of a sequential operation, according to embodiments of the disclosure.

### DETAILED DESCRIPTION

It is to be understood that the following disclosure provides many different embodiments, or examples, for implementing different features of the disclosure. Specific embodiments or examples of components and arrangements are described below to simplify the present disclosure. These are, of course, merely examples and are not intended to be limiting. For example, dimensions of elements are not limited to the disclosed range or values, but may depend upon process conditions and/or desired properties of the device. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Various features may be arbitrarily drawn in different scales for simplicity and clarity.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The device may be otherwise oriented (rotated 90 degrees or at other orientations) and the spatially relative descriptors used herein may likewise be interpreted accordingly. In addition, the term “made of” may mean either “comprising” or “consisting of.”

A hybrid interconnect structure with torus network topology requires connections between edge processing dies to improve inter-die communication efficiency and reduce both latency and insertion loss of the signal. However, as the quantity of processing dies increases, the latency and insertion loss of the signal also increase due to the limitations on the electrical wiring over an extended distance between the edge processing dies. Embodiments of this disclosure provide an improved interconnect structure with torus network topology, of which optical waveguides and electrical interconnects are combined to form the hybrid interconnect structure, thereby reducing the latency and insertion loss for the interconnect structure. For example, the edge processing dies are optically connected and coupled with each other through the optical waveguides while the processing dies are still electrically connected with each other, thereby achieving low-loss, low-latency, and high-efficiency communications between the processing dies. In addition, electric integrated circuit (EIC) dies and photoelectric integrated circuit (PIC) dies are arranged at the periphery of the array of the processing dies to further enhance the inter-die communication between the processing dies, such that the signal integrity can be further improved.

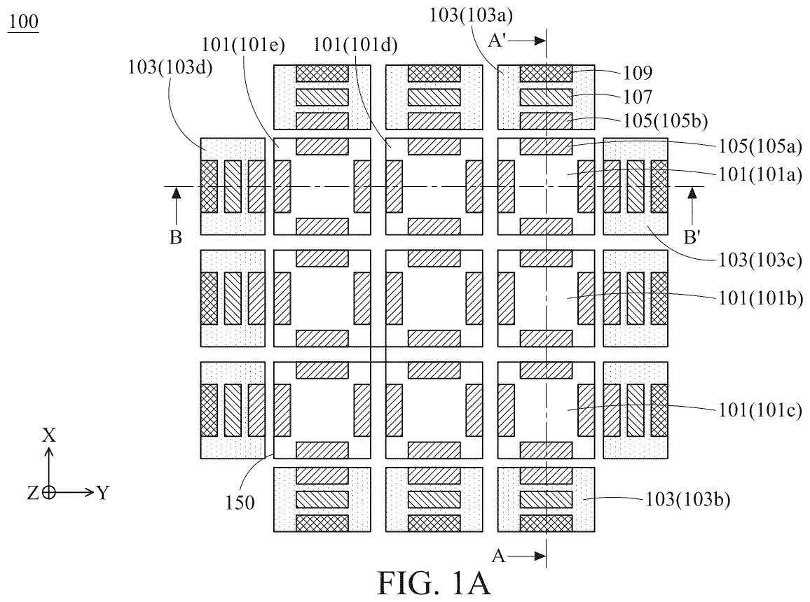

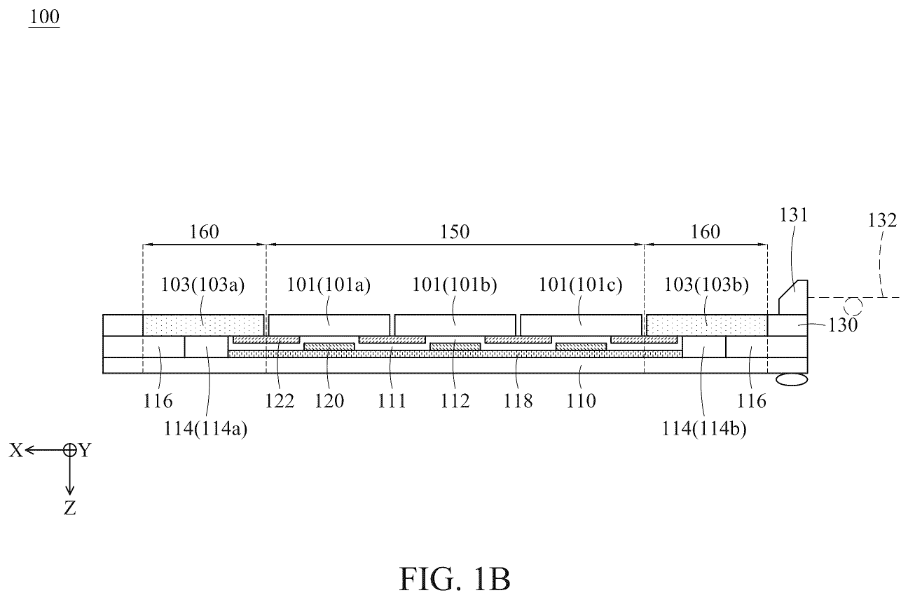

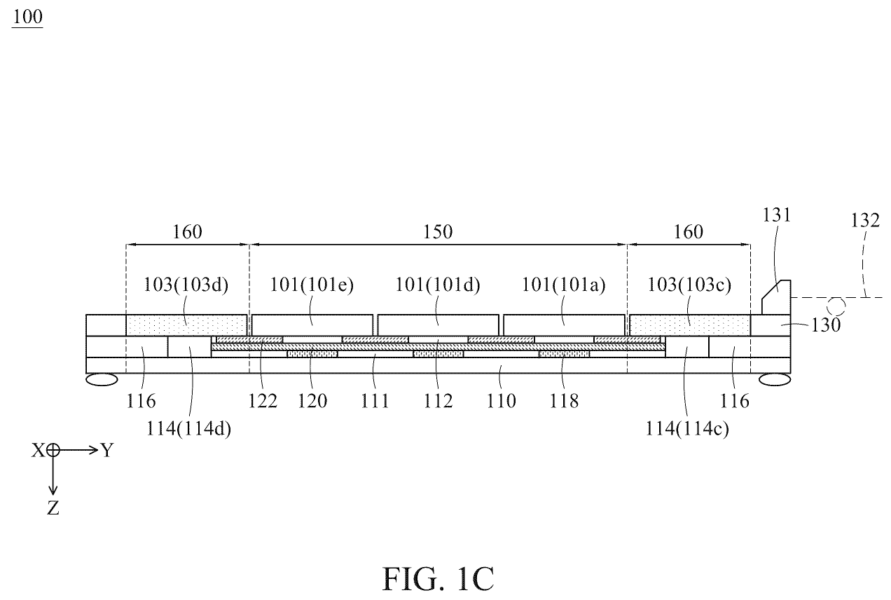

FIG. 1A shows a schematic top view of a semiconductor structure 100, according to embodiments of the disclosure. FIG. 1B shows a schematic cross-sectional view cut along the AA′ line of the semiconductor structure 100 in FIG. 1A, according to embodiments of the disclosure. FIG. 1C shows a schematic cross-sectional view cut along the BB′ line of the semiconductor structure 100 in FIG. 1A, according to embodiments of the disclosure.

As shown in FIG. 1A, in some embodiments, the semiconductor structure 100 includes a plurality of processing dies 101. In some embodiments, the plurality of processing dies 101 form a cluster. In some embodiments, the plurality of processing dies 101 are arranged in an array 150. For illustration purposes, only nine computing units are shown in FIG. 1A and arranged in a 3×3 array. In some embodiments, the array 150 is a M*N array, where M and N are any positive integer numbers. In some embodiments, the array 150 is not limited to a 2-dimension array.

In some embodiments, the semiconductor structure 100 is a fan-out panel package and has a square top-view shape as shown in FIG. 1A. Alternatively, in some embodiments, the semiconductor structure 100 is a wafer-level package and has a round top view shape (not shown in FIG. 1A). In some embodiments, the semiconductor structure 100 is an interconnect structure.

In some embodiments, the plurality of processing dies 101 are cross processing unit (xPU) dies (e.g., central processing unit (CPU) dies, graphic processing unit (GPU) dies, tensor processing unit (TPU) dies, data processing unit (DPU) dies, neural processing unit (NPU) dies, microcontroller dies, etc.) configured to perform parallel processing tasks. In some embodiments, the plurality of processing dies 101 are GPU dies.

As shown in FIG. 1A, in some embodiments, the semiconductor structure 100 further includes a plurality of electric integrated circuit (EIC) dies 103. In some embodiments, the plurality of electric integrated circuit dies 103 are arranged at a periphery 160 of the array 150. For example, the plurality of electric integrated circuit dies 103 are placed around the plurality of processing dies 101. In some embodiments, each of the plurality of electric integrated circuit dies 103 is placed adjacent to a corresponding processing die of the plurality of processing dies 101.

In some embodiments, the plurality of electric integrated circuit dies 103 are configured to transmit electrical signals from and/or to the plurality of processing dies 101.

In some embodiments, the plurality of electric integrated circuit dies 103 are logic dies (e.g., central processing unit (CPU) dies, graphic processing unit (GPU) dies, microcontroller dies, etc.), memory dies (e.g., dynamic random access memory (DRAM) dies, static random access memory (SRAM) dies, high bandwidth memory (HBM) dies, etc.), power management dies (e.g., power management integrated circuit (PMIC) dies), radio frequency (RF) dies, micro-electro-mechanical-system (MEMS) dies, signal processing dies (e.g., digital signal processing (DSP) dies), front-end dies (e.g., analog front-end (AFE) dies), system-on-chip (SoC) dies, or combinations thereof.

In some embodiments, each of the plurality of processing dies 101 includes a chiplet interface 105a. The chiplet interface 105a is an interface configured to electrically connect and/or couple each of the plurality of processing dies 101 with other dies of the semiconductor structure 100. In some embodiments, adjacent processing dies of the plurality of processing dies 101 are electrically connected to and/or coupled with each other through the chiplet interfaces 105a.

In some embodiments, each of the plurality of processing dies 101 includes more than one chiplet interface 105 (e.g., 105a). For example, as shown in FIG. 1A, each of the plurality of processing dies 101 includes four chiplet interfaces 105 (e.g., 105a) arranged at four sides of each of the plurality of processing dies 101. Each of the plurality of processing dies 101 is configured to communicate with four adjacent processing dies 101 through the chiplet interfaces 105 (e.g., 105a).

In some embodiments, each of the plurality of electric integrated circuit dies 103 includes a chiplet interface 105b. In some embodiments, each of the plurality of electric integrated circuit dies 103 is electrically connected to and/or coupled with adjacent processing dies of the plurality of processing dies 101 through the chiplet interfaces 105b.

In some embodiments, each of the plurality of electric integrated circuit dies 103 further includes an internal optical interface 107. The internal optical interface 107 is configured to optically connect and/or couple the plurality of electric integrated circuit dies 103 with each other.

In some embodiments, each of the plurality of electric integrated circuit dies 103 further includes an external optical interface 109. The external optical interface 109 is configured to optically connect and/or couple the plurality of electric integrated circuit dies 103 with an external fiber connector, such that the semiconductor structure 100 can communicate optically with another semiconductor structure through the external optical interface 109.

As shown in FIG. 1B and FIG. 1C, in some embodiments, the semiconductor structure 100 further includes a substrate 110. In some embodiments, the substrate 110 is a glass substrate. In some embodiments, the substrate 110 is a ceramic substrate. In some embodiments, the substrate 110 is a carrier substrate, such that multiple dies can be arranged over the substrate 110.

In some embodiments, the semiconductor structure 100 further includes a waveguide layer 111 formed on the substrate 110 and a redistribution layer 112 formed on the waveguide layer 111. The redistribution layer 112 may include a dielectric layer or a plurality of dielectric layers stacked on each other.

In some embodiments, the semiconductor structure 100 further includes conductive wires 122 disposed in trenches and/or vias of the redistribution layer 112.

In some embodiments, as shown in FIG. 1A and FIG. 1B, the conductive wires 122 are configured to be electrically connected to and/or coupled with the plurality of processing dies 101 through the chiplet interfaces 105a. In some embodiments, the conductive wires 122 are configured to be electrically connected to and/or coupled with the plurality of electric integrated circuit dies 103 through the chiplet interfaces 105b.

In some embodiments, adjacent processing dies (e.g., 101a and 101b, or 101b and 101c) of the plurality of processing dies 101 are electrically connected to and/or coupled with each other through the conductive wires 122 and the chiplet interfaces 105 (e.g., 105a). For example, a processing die (e.g., 101a) of the plurality of processing dies 101 is electrically connected to and/or coupled with an adjacent processing die (e.g., 101a) of the plurality of processing dies 101 through the conductive wires 122 and the chiplet interfaces 105 (e.g., 105a).

In some embodiments, a processing die (e.g., 101a) of the plurality of processing dies 101 is electrically connected to and/or coupled with an adjacent electric integrated circuit die (e.g., 103a) of the plurality of electric integrated circuit dies 103. In some embodiments, a processing die (e.g., 101e) of the plurality of processing dies 101 is electrically connected to and/or coupled with an adjacent electric integrated circuit die (e.g., 103d) of the plurality of electric integrated circuit dies 103 through the chiplet interfaces 105a, the conductive wires 122, and the chiplet interfaces 105b.

In some embodiments, the waveguide layer 111 includes a plurality of waveguides (e.g., 118 and 120) formed in the waveguide layer 111. Each of the plurality of waveguides (e.g., 118 and 120) is configured to optically connect and/or couple two electric integrated circuit dies 103 with each other. In some embodiments, the plurality of waveguides (e.g., 118 and 120) include a plurality of first waveguides 118 and a plurality of second waveguides 120.

In some embodiments, the plurality of waveguides (e.g., 118 and 120) are made of silicon, silicon nitride, other suitable silicon compounds, or other suitable semiconductor materials.

For example, as shown in FIG. 1B, a first electric integrated circuit die 103a is connected to and/or coupled with a second electric integrated circuit die 103b, where the first electric integrated circuit die 103a and the second electric integrated circuit die 103b are arranged at opposite edges of the array 150 in the x direction. For example, as shown in FIG. 1C, a third electric integrated circuit die 103c is connected to and/or coupled with a fourth electric integrated circuit die 103d, where the third electric integrated circuit die 103c and the fourth electric integrated circuit die 103d are arranged at opposite edges of the array 150 in the y direction. In some embodiments, the y direction is perpendicular to the x direction.

Alternatively, in some embodiments, the first electric integrated circuit die 103a is connected to and/or coupled with any other electric integrated circuit die 103 of the plurality of electric integrated circuit dies 103 at a different edge of the array 150.

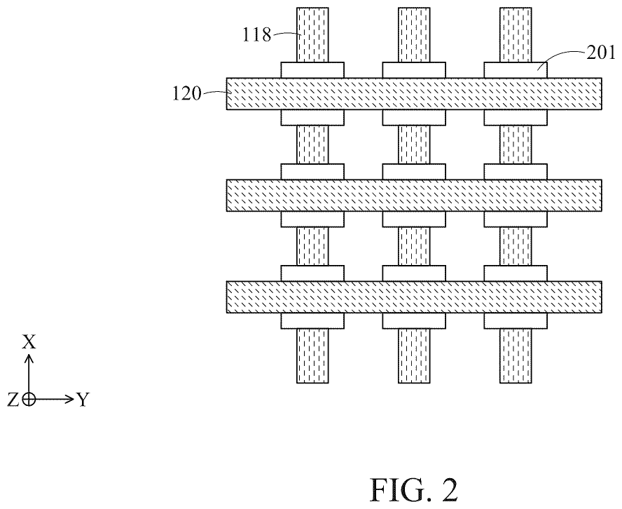

FIG. 2 shows a schematic top view of the plurality of waveguides of FIG. 1B and FIG. 1C, according to embodiments of the disclosure.

In some embodiments, as shown in FIG. 2, the plurality of first waveguides 118 extend in the x direction and are spaced from each other in the y direction. In some embodiments, the plurality of second waveguides 120 extend in the y direction and are spaced from each other in the x direction.

Referring back to FIG. 1B and FIG. 1C, in some embodiments, the plurality of first waveguides 118 and the plurality of second waveguides 120 are formed on different layers of the waveguide layer 111. For example, the plurality of second waveguides 120 are formed over the plurality of first waveguides 118.

In some embodiments, as shown in FIG. 2, a dielectric spacer 201 is formed between the plurality of first waveguides 118 and the plurality of second waveguides 120 to separate the plurality of second waveguides 120 from the plurality of first waveguides 118, such that no crosstalk occurs between the plurality of first waveguides 118 and the plurality of second waveguides 120 to prevent optical loss.

Referring back to FIG. 1B and FIG. 1C, in some embodiments, the semiconductor structure 100 further includes a plurality of photoelectric integrated circuit (PIC) dies 114 to provide an optical communication channel between the plurality of waveguides (e.g., 118 and 120) and the plurality of electric integrated circuit dies 103.

In some embodiments, each of the plurality of photoelectric integrated circuit dies 114 includes an optical input/output terminal configured to transmit and receive optical signals. The optical signals are, for example, pulsed light, light with continuous wave (CW), and/or the combinations thereof. In some embodiments, the optical input/output terminals of each of the plurality of photoelectric integrated circuit dies 114 include semiconductor waveguides, photo-detectors (PD), amplifiers (AF), modulators (MOD), and/or various devices and circuits (not shown) to receive, process, and/or transmit optical signals from the plurality of waveguides (e.g., 118 and 120). In some embodiments, the photo-detector and the amplifier are configured to convert the optical signals into electrical signals. When the photo-detector receives or detects the optical signals from the semiconductor waveguide, the optical signals are converted into photo-current by the photo-detector, and the amplifier converts the photo-current supplied by the photo-detectors into voltage. In some embodiments, the modulator is configured to modulate the optical signals from the plurality of waveguides (e.g., 118 and 120). The photo-detectors may include photo-diodes, or the like. The amplifiers may include trans-impedance amplifiers (TIA), or the like.

In some embodiments, the plurality of photoelectric integrated circuit dies 114 convert electrical signals from the plurality of electric integrated circuit dies 103 to optical signals. Alternatively, in some embodiments, the plurality of photoelectric integrated circuit dies 114 convert optical signals to electrical signals and then transmit the electrical signals to the plurality of electric integrated circuit dies 103. In some embodiments, the plurality of electric integrated circuit dies 103 transmit electrical signals from and/or to the plurality of photoelectric integrated circuit dies 114.

In some embodiments, as shown in FIG. 1B and FIG. 1C, the plurality of photoelectric integrated circuit dies 114 are embedded in the waveguide layer 111 and the redistribution layer 112. In some embodiments, the plurality of photoelectric integrated circuit dies 114 are arranged on a substrate 110. In some embodiments, the plurality of photoelectric integrated circuit dies 114 are arranged at the periphery 160 of the array 150. In some embodiments, each of the plurality of photoelectric integrated circuit dies 114 is arranged below a corresponding electric integrated circuit die of the plurality of electric integrated circuit dies 103.

In some embodiments, the plurality of photoelectric integrated circuit dies 114 are connected to and/or coupled with the plurality of electric integrated circuit dies 103. In some embodiments, the plurality of photoelectric integrated circuit dies 114 are connected to and/or coupled with the plurality of electric integrated circuit dies 103 through the internal optical interface 107.

In some embodiments, as shown in FIG. 1B, a first photoelectric integrated circuit die 114a and a second photoelectric integrated circuit die 114b are arranged on opposite edges of the array 150 along the x direction. In some embodiments, the first photoelectric integrated circuit die 114a is optically connected to and/or coupled with one end of a corresponding first waveguide of the plurality of first waveguides 118. In some embodiments, the second photoelectric integrated circuit die 114b is optically connected to and/or coupled with the other end of the corresponding first waveguide of the plurality of first waveguides 118.

In some embodiments, the first photoelectric integrated circuit die 114a is connected to and/or coupled with the first electric integrated circuit die 103a. In some embodiments, the second photoelectric integrated circuit die 114b is connected to and/or coupled with the second electric integrated circuit die 103 b. As such, a first edge processing die (e.g., 101a) can communicate with a second edge processing die (e.g., 101c) through the second electric integrated circuit die 103b, the second photoelectric integrated circuit die 114b, the corresponding first waveguide of the plurality of first waveguides 118, the first photoelectric integrated circuit die 114a, and the first electric integrated circuit die 103a sequentially.

In some embodiments, as shown in FIG. 1C, a third photoelectric integrated circuit die 114c and a fourth photoelectric integrated circuit die 114d are arranged on opposite edges of the array 150 along the y direction. In some embodiments, the third photoelectric integrated circuit die 114c is optically connected to and/or coupled with one end of a corresponding second waveguide 120. In some embodiments, the fourth photoelectric integrated circuit die 114d is optically connected to and/or coupled with the other end of the corresponding second waveguide 120.

In some embodiments, the third photoelectric integrated circuit die 114c is connected to and/or coupled with the third electric integrated circuit die 103c. In some embodiments, the fourth photoelectric integrated circuit die 114d is connected to and/or coupled with the fourth electric integrated circuit die 103 d. As such, the first edge processing die (e.g., 101a) can communicate with a third edge processing die (e.g., 101e) through the third electric integrated circuit die 103c, the third photoelectric integrated circuit die 114c, the corresponding second waveguide 120, the fourth photoelectric integrated circuit die 114d, and the fourth electric integrated circuit die 103d sequentially.

In some embodiments, the second edge processing die (e.g., 101c) can communicate with a third edge processing die (e.g., 101e) through the first edge processing die (e.g., 101a), the first waveguide 118, and the second waveguide 120. In some embodiments, other edge processing dies can also communicate with each other through the first waveguide 118 and the second waveguide 120. Edges processing dies can communicate with each other through waveguides without hopping through all the electrical connections between the edge processing dies, such that the communication efficiency and integrity between the plurality of processing dies can be improved and the signal loss can be minimized.

Referring back to FIG. 1B and FIG. 1C, in some embodiments, the semiconductor structure 100 further includes a plurality of external photoelectric integrated circuit dies 116. In some embodiments, the plurality of external photoelectric integrated circuit dies 116 are embedded in the waveguide layer 111 and the redistribution layer 112. In some embodiments, the plurality of external photoelectric integrated circuit dies 116 are arranged on a substrate 110. In some embodiments, the plurality of external photoelectric integrated circuit dies 116 are arranged at the periphery 160 of the array 150.

In some embodiments, the plurality of external photoelectric integrated circuit dies 116 are optically connected to and/or coupled with the plurality of electric integrated circuit dies 103. In some embodiments, the plurality of external photoelectric integrated circuit dies 116 are optically connected to and/or coupled with the plurality of electric integrated circuit dies 103 through the external optical interface 109.

In some embodiments, each of the plurality of external photoelectric integrated circuit dies 116 is optically connected to and/or coupled with an adjacent electric integrated circuit die (e.g., 103a, 103b, 103c, or 103d) of the plurality of electric integrated circuit dies 103.

In some embodiments, the plurality of external photoelectric integrated circuit dies 116 are configured to optically connect and/or couple the semiconductor structure 100 with other semiconductor structures (not shown), such that multiple semiconductor structures can be integrated to scale up the cluster of the processing dies. In some examples, the plurality of external photoelectric integrated circuit dies 116 are connected to and/or coupled with other semiconductor structures through connecting elements, such as a silicon based connecting element with a lens 130, a fiber aligner 131, a fiber 132, and/or combinations thereof.

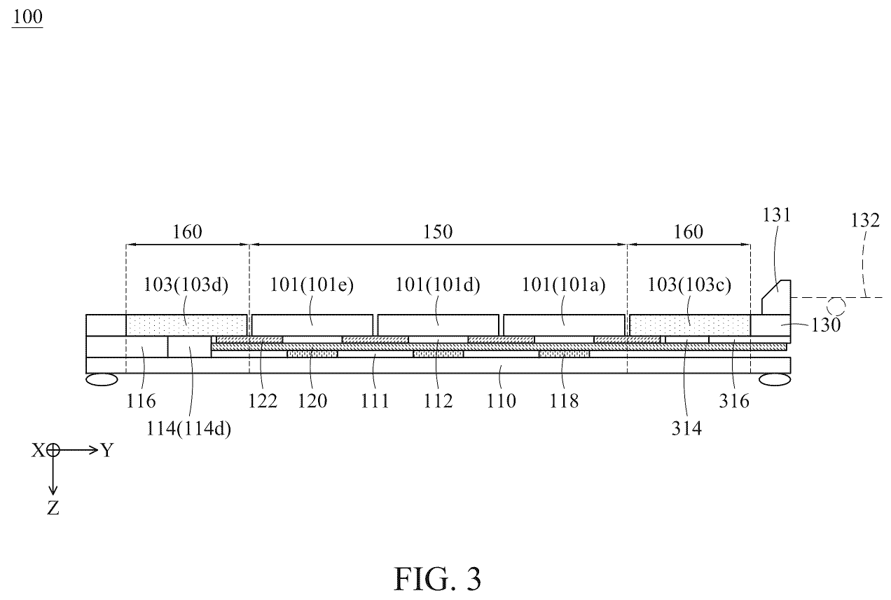

FIG. 3 shows a schematic cross-sectional view cut along the BB′ line of the semiconductor structure 100 in FIG. 1A, according to embodiments of the disclosure. Components of the semiconductor structure 100 described herein may correspond to the components of the semiconductor structure 100 as described in FIG. 1C, except that at least one of the plurality of photoelectric integrated circuit dies 114 and at least one of the plurality of external photoelectric integrated circuit (PIC) dies 116 are arranged on the plurality of second waveguides 120.

In some embodiments, as shown in FIG. 3, a fifth photoelectric integrated circuit die 314 of the plurality of photoelectric integrated circuit dies 114 is embedded in the redistribution layer 112. In some embodiments, the fifth photoelectric integrated circuit die 314 of the plurality of photoelectric integrated circuit dies 114 is arranged on a corresponding second waveguide of the plurality of second waveguides 120.

In some embodiments, an external photoelectric integrated circuit die 316 of the plurality of external photoelectric integrated circuit dies 116 is embedded in the redistribution layer 112. In some embodiments, the external photoelectric integrated circuit die 316 of the plurality of external photoelectric integrated circuit dies 116 is disposed on the corresponding second waveguide of the plurality of second waveguides 120. Alternatively, in some embodiments, the external photoelectric integrated circuit die 316 of the plurality of external photoelectric integrated circuit dies 116 is disposed on a corresponding first waveguide of the plurality of first waveguides 118.

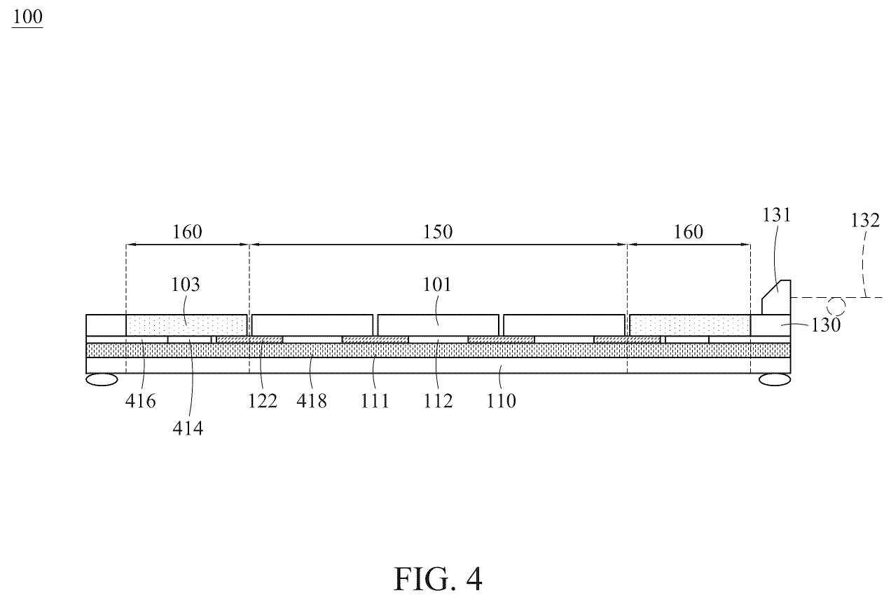

FIG. 4 shows a schematic cross-sectional view cut along the AA′ line of the semiconductor structure 100 in FIG. 1A, according to embodiments of the disclosure. Components of the semiconductor structure 100 described herein may correspond to the components of the semiconductor structure 100 as described in FIG. 1A and FIG. 1B, except that a plurality of photoelectric integrated circuit dies 414 and a plurality of external photoelectric integrated circuit dies 416 are arranged on a plurality of waveguides 418. For the sake of simplicity, only one waveguide of the plurality of waveguides 418 is shown along the AA′ line of the semiconductor structure 100. For a similar reason, a cross-sectional view cut along the BB′ line, which would be similar to the cross-sectional view cut along the AA′ line of the semiconductor structure 100 is not shown, in accordance with some embodiments.

In some embodiments, the semiconductor structure 100 includes a plurality of waveguides 418 formed in trenches of the waveguide layer 111. Each of the plurality of waveguides 418 is configured to optically connect and/or couple two electric integrated circuit dies 103.

In some embodiments, the plurality of waveguides 418 are made of silicon, silicon nitride, other suitable silicon compounds, or other suitable semiconductor materials.

In some embodiments, as shown in FIG. 4, the plurality of photoelectric integrated circuit dies 414 are embedded in the redistribution layer 112. In some embodiments, the plurality of photoelectric integrated circuit dies 414 are arranged on the waveguide layer 111. In some embodiments, the plurality of photoelectric integrated circuit dies 414 are arranged on the plurality of waveguides 418.

In some embodiments, the plurality of external photoelectric integrated circuit dies 416 are embedded in the redistribution layer 112. In some embodiments, the plurality of external photoelectric integrated circuit dies 416 are arranged on the waveguide layer 111. In some embodiments, the plurality of external photoelectric integrated circuit dies 416 are arranged on the plurality of waveguides 418.

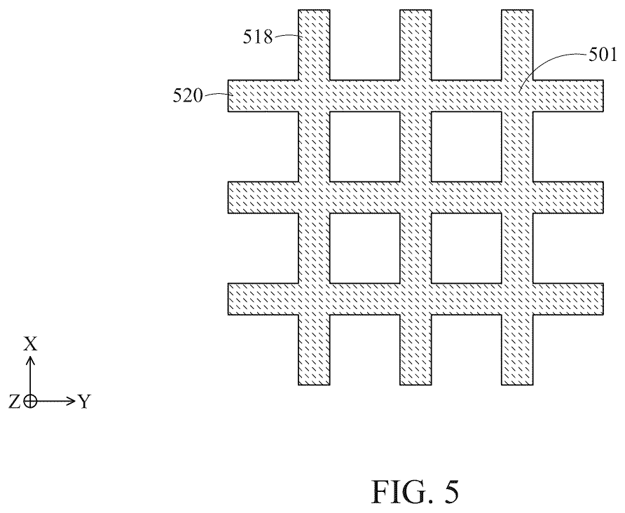

FIG. 5 shows a schematic top view of the plurality of waveguides, according to embodiments of the disclosure. The plurality of waveguides described herein may correspond to the plurality of waveguides 418 as described in FIG. 4.

In some embodiments, as shown in FIG. 5, the plurality of waveguides include a plurality of first waveguides 518 and a plurality of second waveguides 520. In some embodiments, the plurality of first waveguides 518 extend in the x direction and are spaced from each other in the y direction. In some embodiments, the plurality of second waveguides 520 extend in the y direction and are spaced from each other in the x direction.

Alternatively to the arrangement of FIG. 2, in some embodiments, as shown in FIG. 5, the plurality of first waveguides 518 and the plurality of second waveguides 520 are formed on the same layer of the waveguide layer 111. In some embodiments, the plurality of second waveguides 520 and the plurality of first waveguides 518 cross each other at intersection regions 501.

The size (e.g., thickness) of the semiconductor structure may be reduced by arranging the plurality of first waveguides 518 and the plurality of second waveguides 520 in the same layer of the waveguide layer 111. Crosstalk may occur at the crossings between the plurality of first waveguides 518 and the plurality of second waveguides 520. However, the optical loss due to the crosstalk at the crossings may be minimized by using mode transformation techniques or tapered crossing techniques.

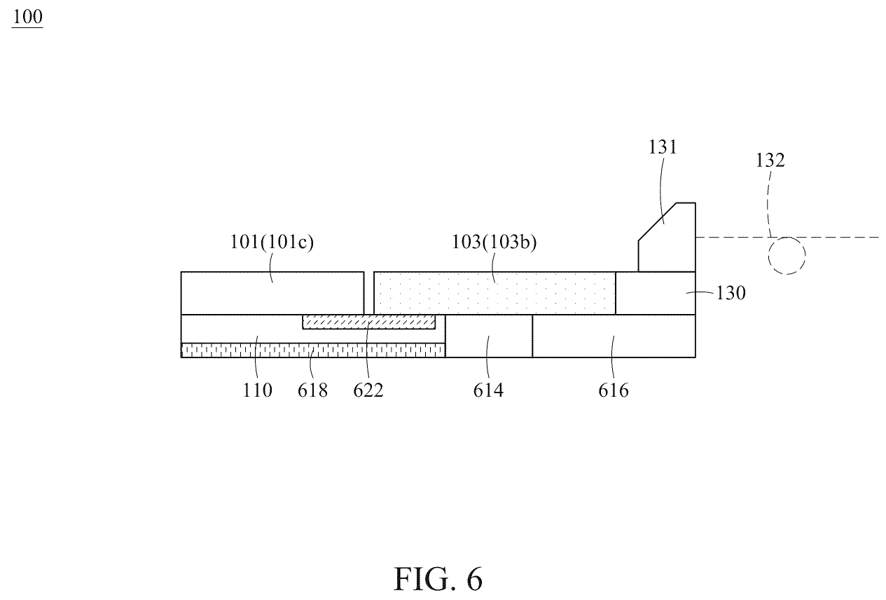

FIG. 6 shows a schematic cross-sectional view cut along the AA′ line of a portion of the semiconductor structure 100, according to embodiments of the disclosure. Components of the semiconductor structure 100 described herein may correspond to the components of the semiconductor structure 100 as described in FIG. 1A and FIG. 1B, except that a plurality of photoelectric integrated circuit dies 614 and a plurality of external photoelectric integrated circuit dies 616 are disposed at edges of the substrate 110, and conductive wires 622 are disposed in the substrate 110.

In some embodiments, the semiconductor structure 100 includes a plurality of waveguides 618 formed in the substrate 110. In some embodiments, as shown in FIG. 6, the plurality of waveguides 618 are formed on the bottom of the substrate 110. For the sake of simplicity, only one waveguide of the plurality of waveguides 618 is shown along the AA′ line of the semiconductor structure 100.

In some embodiments, each of the plurality of waveguides 618 is configured to connect and/or couple two electric integrated circuit dies 103 through the plurality of photoelectric integrated circuit dies 614. In some embodiments, the two electric integrated circuit dies 103 are arranged at opposite edges of the array 150.

The plurality of photoelectric integrated circuit dies 614 and the plurality of waveguides 618 are both arranged at edges of the array 150 and at the edges of the substrate 110, such that the plurality of photoelectric integrated circuit dies 614 and the plurality of waveguides 618 can be coupled with each other with an edge coupler (not shown).

In some embodiments, trenches or holes are formed in the substrate 110, and the plurality of photoelectric integrated circuit dies 614 and the plurality of waveguides 618 are placed in the trenches or holes of the substrate 110. In some embodiments, the plurality of photoelectric integrated circuit dies 614 and the plurality of waveguides 618 are aligned and coupled with the plurality of waveguides 618.

In some embodiments, the semiconductor structure 100 further includes conductive wires 622 disposed in trenches and/or vias of the substrate 110. In some embodiments, adjacent processing dies (e.g., 101b and 101c as shown in FIG. 1A) of the plurality of processing dies 101 are electrically connected to and/or coupled with each other through the conductive wires 622. In some embodiments, the plurality of processing dies 101 are electrically connected to and/or coupled with the plurality of electric integrated circuit dies 103 through the conductive wires 622.

In some embodiments, waveguides are not formed in the substrate 110. In some embodiments, alternatively, an external waveguide (not shown) is provided to optically connect and/or couple two photoelectric integrated circuit dies of the plurality of photoelectric integrated circuit dies 614. In some embodiments, each of the plurality of photoelectric integrated circuit dies 614 is optically connected to and/or coupled with the external waveguide through a grating coupler (not shown).

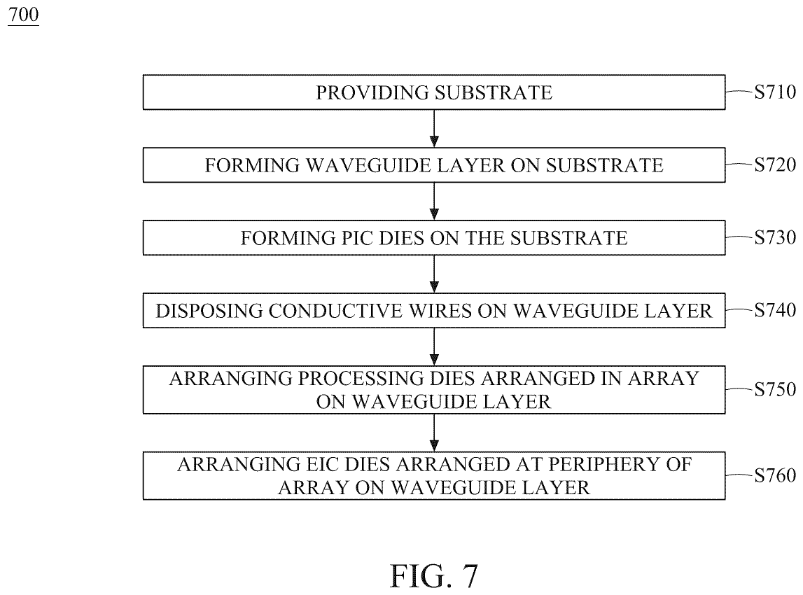

FIG. 7 illustrates a process flow 700 of manufacturing the semiconductor structure 100 according to embodiments of the disclosure.

Referring back to FIG. 1B and FIG. 1C, in some embodiments, a substrate 110 is provided or formed in operation S710.

In some embodiments, a waveguide layer 111 is formed on the substrate 110 in operation S720. The waveguide layer includes a plurality of waveguides.

In some embodiments, the plurality of waveguides include a plurality of first waveguides 118 extending along the x direction and a plurality of second waveguides 120 extending along the y direction.

In some embodiments, a plurality of photoelectric integrated circuit dies 114 are arranged on the substrate 110 in operation S730.

In some embodiments, the plurality of photoelectric integrated circuit dies 114 are arranged at the periphery 160 of the array 150.

In some embodiments, conductive wires 122 are arranged on the waveguide layer 111 in operation S740.

In some embodiments, a plurality of processing dies 101 are arranged in the array 150 on the waveguide layer 111 in operation S750.

In some embodiments, the conductive wires 122 are silicon bridges. In some embodiments, the silicon bridges are configured to electrically couple the plurality of processing dies 101 with each other. In some embodiments, the silicon bridges are configured to electrically couple each of the plurality of electric integrated circuit dies 103 with a corresponding edge processing die of the plurality of processing dies 101.

In some embodiments, a redistribution layer 112 is formed on the waveguide layer 111, and the conductive wires 122 are embedded in the redistribution layer 112.

In some embodiments, the plurality of processing dies 101 are arranged on the conductive wires 122.

In some embodiments, a plurality of electric integrated circuit dies 103 arranged at the periphery 160 of the array 150 are arranged on the waveguide layer 111 and electrically coupled with the plurality of processing dies 101 in operation S760.

In some embodiments, the plurality of electric integrated circuit dies 103 are arranged within the array 150. In some embodiments, the plurality of electric integrated circuit dies 103 are arranged at a center of the array 150.

In some embodiments, the plurality of electric integrated circuit dies 103 and the plurality of processing dies 101 are arranged in a same layer.

In some embodiments, each of the at least two of the plurality of electric integrated circuit dies 103 are optically coupled to the corresponding waveguide of the plurality of waveguides (e.g., 118 and 120) through a corresponding photoelectric integrated circuit die of the plurality of photoelectric integrated circuit dies 114.

In some embodiments, at least two of the plurality of electric integrated circuit dies 103 arranged at opposite edges of the array 150 are coupled to each other through a corresponding waveguide of the plurality of waveguides (e.g., 118 and 120).

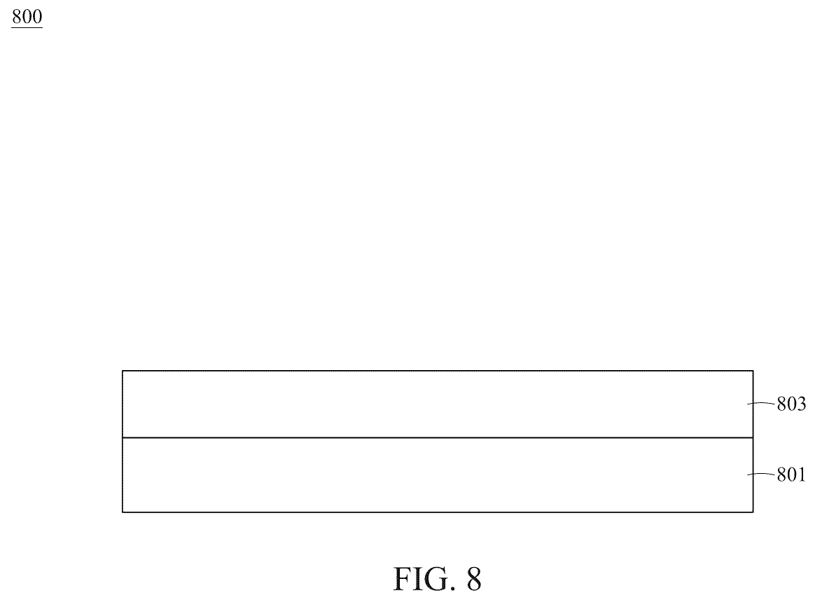

FIG. 8 shows a schematic cross-sectional view 800 of a process stage of a sequential operation of manufacturing a semiconductor device, according to embodiments of the disclosure.

In some embodiments, as shown in FIG. 8 and referring back to operation S710 of FIG. 7, a semiconductor substrate 803 is provided on a carrier layer 801. In some embodiments, the carrier layer 801 is configured to support and carry the semiconductor substrate 803 during the manufacturing process of the semiconductor device.

In some embodiments, the carrier layer 801 is a glass carrier substrate, a ceramic carrier substrate, or the like. In some embodiments, the semiconductor substrate 803 is a silicon substrate.

In some embodiments, a de-bonding layer (not shown) is formed between the carrier layer 801 and the semiconductor substrate 803 to assist the removal of the carrier layer 801 from the semiconductor substrate 803 from overlaying structures that will be formed in subsequent steps.

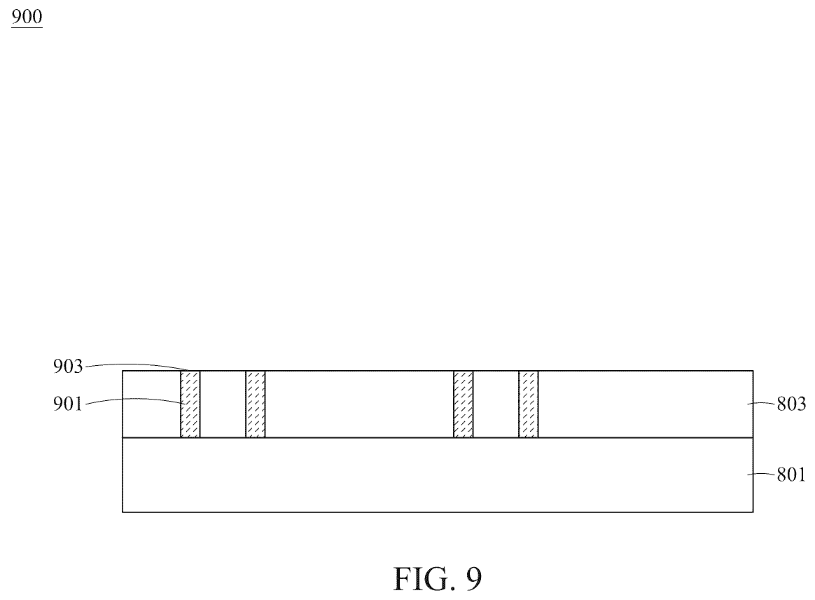

FIG. 9 shows a schematic cross-sectional view 900 of a process stage of a sequential operation of manufacturing the semiconductor device, according to embodiments of the disclosure.

In some embodiments, as shown in FIG. 9, through holes 901 are formed in the semiconductor substrate 803. In some embodiments, the through holes 901 are formed by patterning the semiconductor substrate 803 using photolithographic patterning techniques.

In some embodiments, vias 903 are formed in the through holes 901. The vias 903 are configured to electrically connect dies or layers of the semiconductor device.

In some embodiments, a seed layer (not shown) is formed over the semiconductor substrate 803 and in the through holes 901. In some embodiments, the seed layer is a metal layer, and the metal layer is a single layer or a composite layer including a plurality of sub-layers formed of different materials. In some embodiments, the seed layer includes a titanium layer and a copper layer over the titanium layer. The seed layer is formed using, for example, physical vapor deposition (PVD), or the like. A conductive material is then formed on the seed layer and fills the through holes 901. The conductive material is formed by plating, such as electroplating or electroless plating, or the like in some embodiments. The conductive material includes metals such as copper, titanium, tungsten, aluminum, and/or the like. A planarization process is then performed to remove excess portions of the seed layer and the conductive material outside the through holes 901 to form the vias 903.

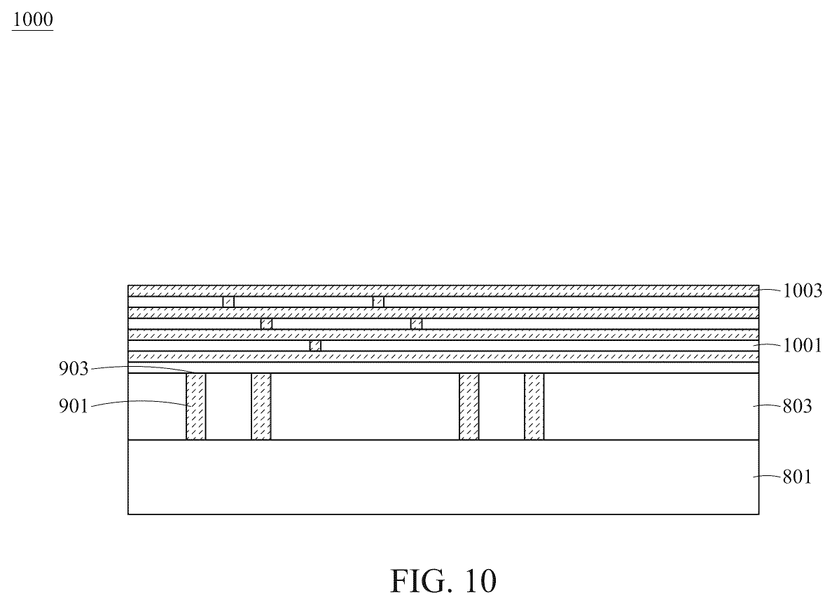

FIG. 10 shows a schematic cross-sectional view 1000 of a process stage of a sequential operation of manufacturing the semiconductor device, according to embodiments of the disclosure.

In some embodiments, as shown in FIG. 10, a first dielectric layer 1001 is formed on the semiconductor substrate 803.

In some embodiments, first redistribution layers 1003 are formed in the first dielectric layer 1001. The first redistribution layers 1003 are configured to reroute the electrical connection between the dies or the layers of the semiconductor device.

In some embodiments, trenches are formed in the first dielectric layer 1001 by patterning the first dielectric layer 1001 using photolithographic patterning techniques. In some embodiments, a seed layer is formed over the first dielectric layer 1001 and in the trenches. In some embodiments, the seed layer is a metal layer, and the metal layer is a single layer or a composite layer including a plurality of sub-layers formed of different materials. In some embodiments, the seed layer includes a titanium layer and a copper layer over the titanium layer. The seed layer is formed using, for example, PVD, or the like. A conductive material is then formed on the seed layer and fills up the trenches. The conductive material is formed by plating, such as electroplating or electroless plating, or the like in some embodiments. The conductive material includes metals such as copper, titanium, tungsten, aluminum, and/or the like. A planarization process is then performed to remove excess portions of the seed layer and the conductive material outside the trenches to form the first redistribution layers 1003. In some embodiments, the planarization process includes a chemical-mechanical planarization (CMP) operation.

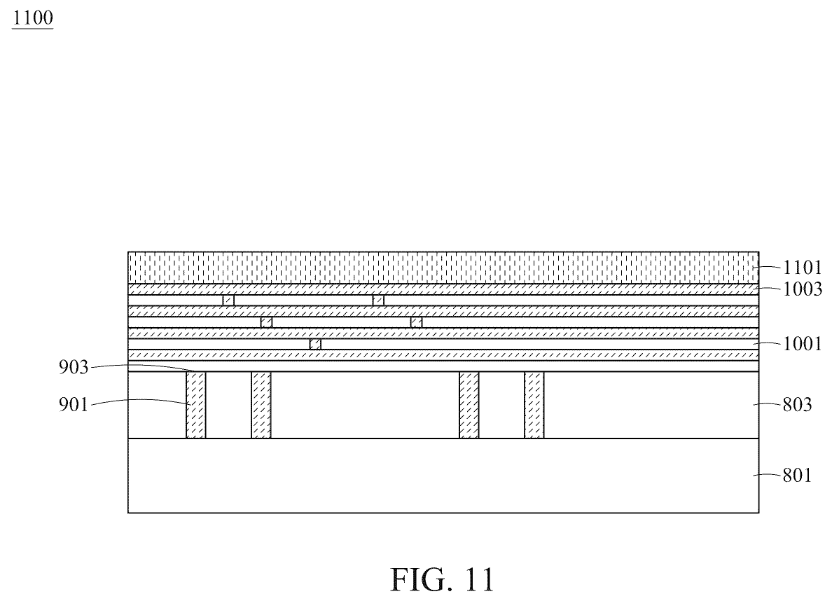

FIG. 11 shows a schematic cross-sectional view 1100 of a process stage of a sequential operation of manufacturing the semiconductor device, according to embodiments of the disclosure.

In some embodiments, as shown in FIG. 11, a waveguide layer 1101 is grown and/or arranged over the first dielectric layer 1001.

In some embodiments, the waveguide layer 1101 is made of a silicon material. In some embodiments, the waveguide layer 1101 is made of a silicon nitride.

In some embodiments, the waveguide layer 1101 is grown and/or arranged over the semiconductor substrate 803 without the first dielectric layer 1001 and the first redistribution layers 1003.

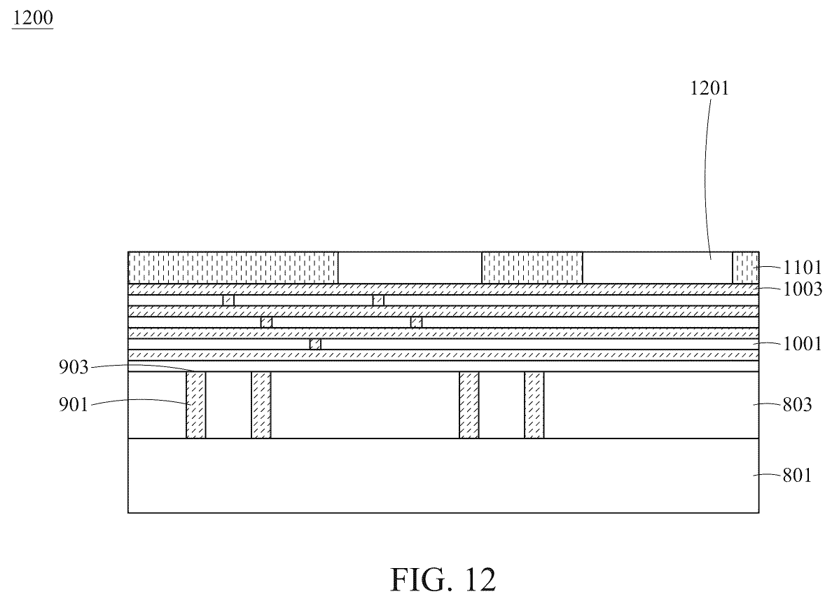

FIG. 12 shows a schematic cross-sectional view 1200 of a process stage of a sequential operation of manufacturing the semiconductor device, according to embodiments of the disclosure.

In some embodiments, as shown in FIG. 12 and referring back to operation S720 of FIG. 7, the waveguide layer 1101 is patterned to form waveguides 1201.

In some embodiments, the waveguide layer 1101 is patterned by photolithographic techniques, including etching, to produce ridge waveguide structures to form the waveguides 1201.

In some embodiments, the waveguides 1201 are configured to optically connect and/or couple the dies or the layers of the semiconductor device with each other.

Although the carrier layer 801, the vias 903, the first dielectric layer 1001, and the first redistribution layers 1003 are shown in FIG. 12, in some embodiments, the waveguides 1201 are formed on the semiconductor substrate 803 without the carrier layer 801, the vias 903, the first dielectric layer 1001, and the first redistribution layers 1003.

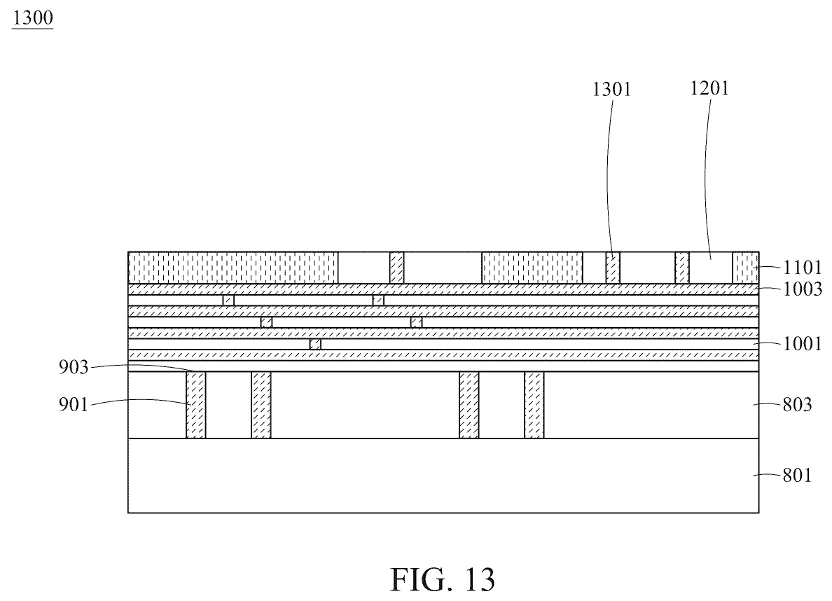

FIG. 13 shows a schematic cross-sectional view 1300 of a process stage of a sequential operation of manufacturing the semiconductor device, according to embodiments of the disclosure.

In some embodiments, as shown in FIG. 13, vias 1301 are formed in the waveguide layer 1101. In some embodiments, the vias 1301 are signal vias configured to transmit electrical signals between the dies or the layers of the semiconductor device. In some embodiments, the vias 1301 are power vias configured to deliver power to or ground the dies or the layers of the semiconductor device.

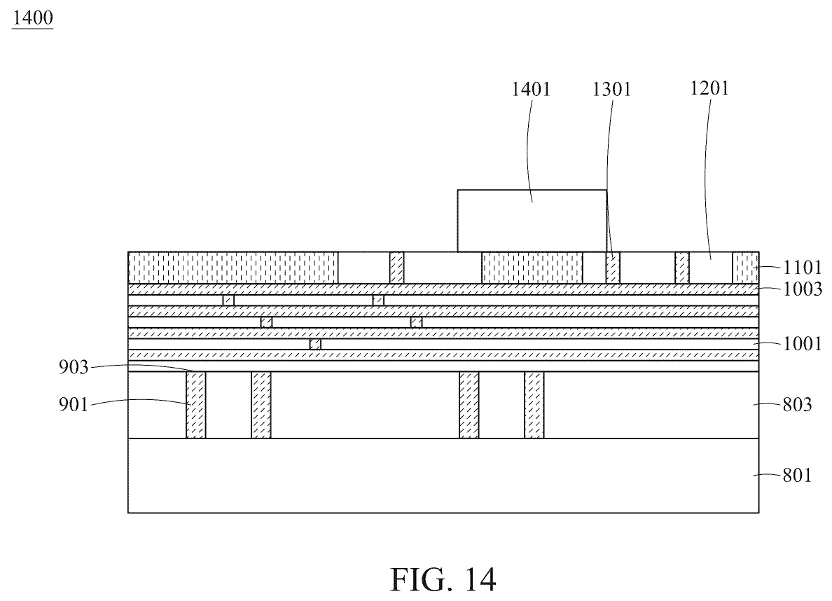

FIG. 14 shows a schematic cross-sectional view 1400 of a process stage of a sequential operation of manufacturing the semiconductor device, according to embodiments of the disclosure.

In some embodiments, as shown in FIG. 14 and referring back to operation S730 of FIG. 7, photoelectric integrated circuit (PIC) dies 1401 are arranged on the waveguide layer 1101. In some embodiments, the PIC dies 1401 are placed on the waveguides 1201 and configured to be optically coupled with the waveguides 1201, such that the PIC dies 1401 are able to communicate with each other through the waveguides 1201. In some embodiments, the PIC dies 1401 are configured to be optically coupled with the waveguides 1201, such that the PIC dies 1401 are able to communicate with other dies or the layers of the semiconductor device. The waveguides 1201 are used for long optical transmission between the PIC dies 1401 to reduce optical loss during the propagation of the optical signals. In some embodiments, each of the PIC dies 1401 includes an optical input/output terminal configured to couple the PIC dies 1401 with the waveguides 1201 to transmit and receive optical signals. In some embodiments, the PIC dies 1401 are aligned and placed on the waveguides 1201 by using a pick-and-place tool.

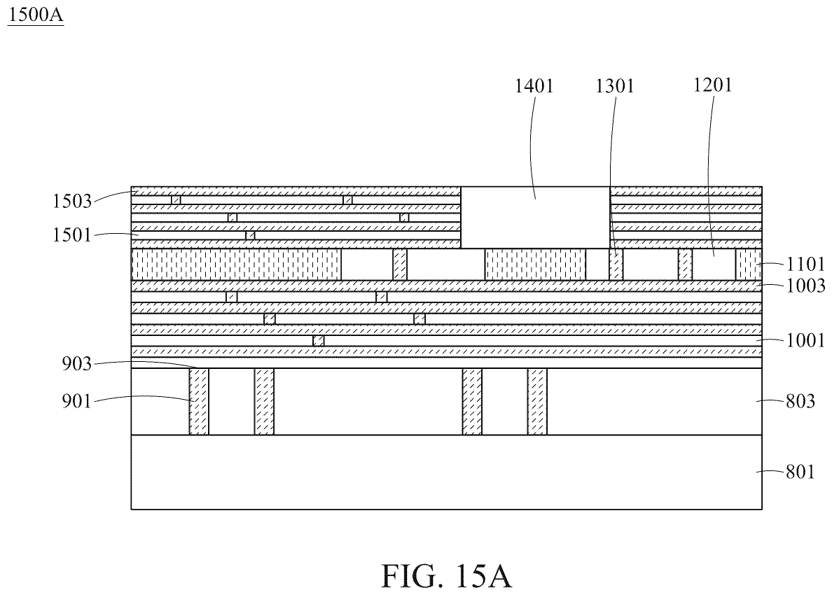

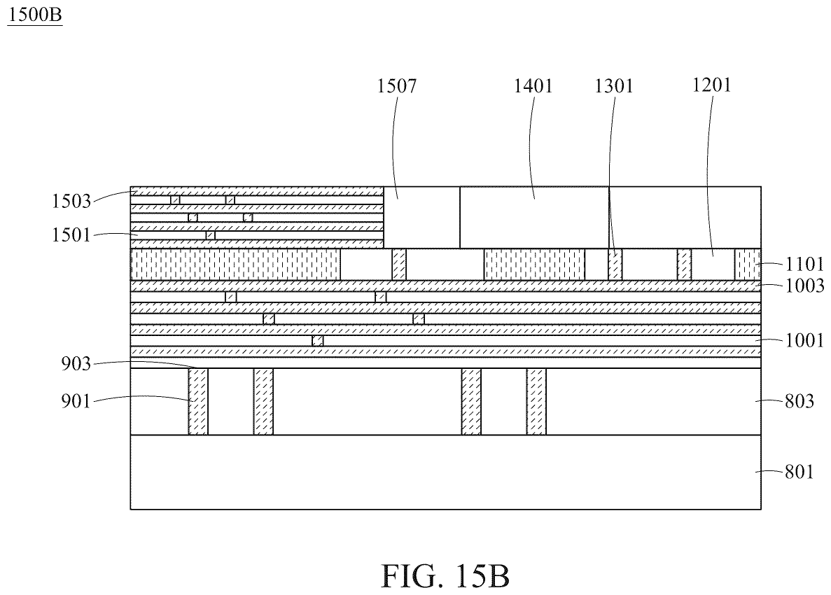

FIG. 15A shows a schematic cross-sectional view 1500A of a process stage of a sequential operation of manufacturing the semiconductor device, according to embodiments of the disclosure. FIG. 15B shows a schematic cross-sectional view 1500B of a process stage of a sequential operation of manufacturing the semiconductor device, according to embodiments of the disclosure.

In some embodiments, as shown in FIG. 15A and referring back to operation S740 of FIG. 7, second redistribution layers (conductive wires) 1503 are formed on the waveguide layer 1101. In some embodiments, a second dielectric layer 1501 is grown on the waveguide layer 1101 to cover the second redistribution layers 1503.

Alternatively, in some embodiments, as shown in FIG. 15B and referring back to operation S740 of FIG. 7, the second redistribution layers (conductive wires) 1503 and a silicon interposer 1507 are arranged on the waveguide layer 1101. In some embodiments, the second dielectric layer 1501 is grown or deposited on the waveguide layer 1101 to cover the second redistribution layers 1503 and the silicon interposer 1507.

In some embodiments, the second redistribution layers 1503 are configured for chiplet interconnections between the dies or the layers of the semiconductor device.

In some embodiments, the second redistribution layers 1503 are formed by a similar method as the first redistribution layers 1003.

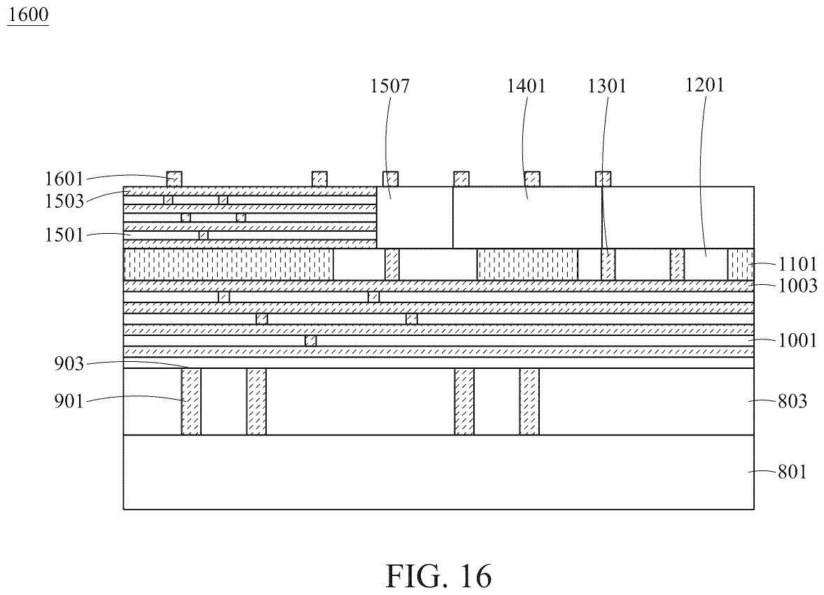

FIG. 16 shows a schematic cross-sectional view 1600 of a process stage of a sequential operation of manufacturing the semiconductor device, according to embodiments of the disclosure.

In some embodiments, as shown in FIG. 16, pillars 1601 are grown on the PIC dies 1401, the second redistribution layers 1503, and the silicon interposer 1507. In some embodiments, the pillars 1601 are copper pillars. In some embodiments, the pillars 1601 are aluminum, nickel, silver, gold, and/or tungsten pillars.

In some embodiments, the pillars 1601 include a layer comprising substantially pure elemental copper, copper containing unavoidable impurities, and copper alloys containing minor amounts of elements such as tantalum, indium, tin, zinc, manganese, chromium, titanium, germanium, strontium, platinum, magnesium, aluminum, cobalt or zirconium. In some embodiments, the pillars 1601 make electrical contact with the PIC dies 1401 and the second redistribution layers 1503.

In some embodiments, the pillars 1601 are formed using photolithographic patterning, plating, and photoresist stripping operations.

In some embodiments, pillars 1601 are arranged and bonded on the PIC dies 1401 and the second redistribution layers 1503. In some embodiments, the pillars 1601 are bonded with the second redistribution layers 1503 by a hybrid bonding process.

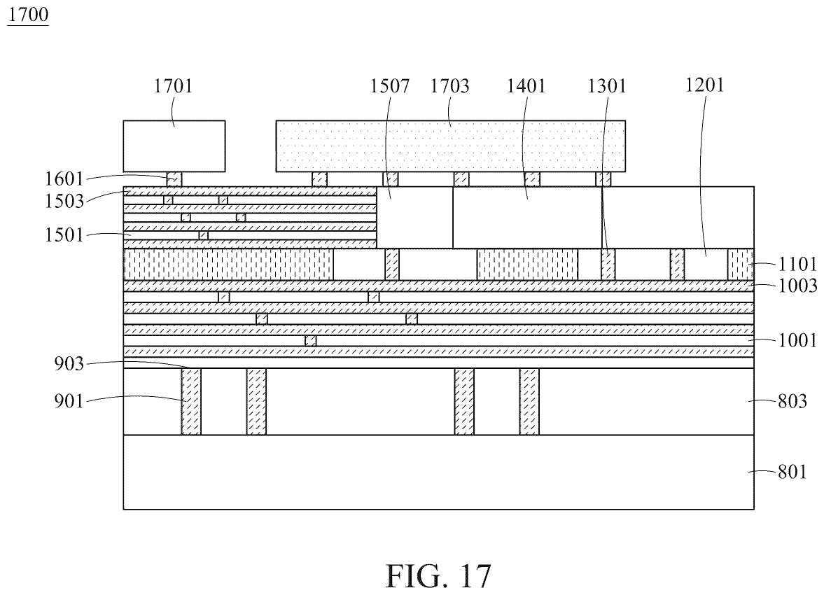

FIG. 17 shows a schematic cross-sectional view 1700 of a process stage of a sequential operation of manufacturing the semiconductor device, according to embodiments of the disclosure.

In some embodiments, as shown in FIG. 17 and referring back to operation S750 of FIG. 7, processing dies 1701 are placed on and/or coupled with the pillars 1601. Additionally, in some embodiments, referring back to operation S760 of FIG. 7, electric integrated circuit (EIC) dies 1703 are arranged on and coupled with the pillars 1601.

In some embodiments, the processing dies 1701 are electrically coupled with each other through the pillars 1601. In some embodiments, the processing dies 1701 are electrically coupled with the EIC dies 1703 through the pillars 1601.

In some embodiments, the EIC dies 1703 are electrically coupled with the PIC dies 1401 through the pillars 1601.

In some embodiments, the processing dies 1701 and the EIC dies 1703 are aligned and placed on the pillars 1601 by using a pick-and-place tool.

Although the pillars 1601 are shown in FIG. 17, in some embodiments, the EIC dies 1703 are coupled with the PIC dies 1401 without the pillars 1601.

In some embodiments, a first processing die 1701 can communicate with a second processing die 1701 through a first EIC die 1703, a first PIC die 1401, the waveguide 1201, a second PIC die 1401, and a second EIC die 1703 sequentially. In some embodiments, the first processing die and the second processing die are edge processing dies.

In some embodiments, the semiconductor device of FIG. 17 is flipped and the carrier layer 801 is removed to expose a back surface of the semiconductor substrate 803. In some embodiments, controlled collapse chip connection (C4) bumps (not shown) are formed on the back surface of the semiconductor substrate 803 to provide electrical connections to the vias 903.

In some embodiments, the steps of the process flow 700 described in FIG. 7 are executed in the order shown. In some embodiments, the steps of the process flow 700 are performed in a different order than the order shown in FIG. 7. In some embodiments, one or more steps are performed before, between, during, and/or after performing one or more steps of the process flow 700. In some embodiments, the order of fabrication steps and elements described in the FIGS. 8-17 are different in various embodiments. In some embodiments, one or more steps are performed before, between, during, and/or after performing one or more of the fabrication steps described in the FIGS. 8-17.

The novel hybrid interconnect structure with torus network topology and the manufacturing methods according to the present disclosure provide improved connections between edge processing dies, thereby reducing the latency and insertion loss for the hybrid interconnect structure and maintaining the communication efficiency between the processing dies than conventional techniques and configurations. Embodiments of the disclosure provide an improved interconnect structure with optical waveguides and electrical interconnects combined to form the hybrid interconnect structure, thereby reducing the latency and insertion loss for the interconnect structure. Consequently, low-loss, low-latency, and high-efficiency communications between the processing dies can be achieved.

An embodiment of the disclosure is a semiconductor structure, which includes a substrate and a waveguide layer formed on the substrate. The waveguide layer includes a plurality of waveguides. The semiconductor structure further includes a plurality of processing dies arranged in an array on the waveguide layer, and a plurality of electric integrated circuit (EIC) dies arranged at a periphery of the array on the waveguide layer and electrically coupled with the plurality of processing dies. At least two of the plurality of EIC dies arranged at opposite edges of the array are optically coupled to each other through a corresponding waveguide of the plurality of waveguides. In an embodiment, the semiconductor structure further includes a plurality of photoelectric integrated circuit (PIC) dies, where each of the at least two of the plurality of EIC dies are coupled to the corresponding waveguide of the plurality of waveguides through a corresponding PIC die of the plurality of PIC dies. In an embodiment, the plurality of PIC dies are arranged on the substrate at the periphery of the array. In an embodiment, the plurality of waveguides include a plurality of first waveguides extending along a first direction, and a plurality of second waveguides extending along a second direction, where the first and second directions are different directions. In an embodiment, the plurality of second waveguides are formed over the plurality of first waveguides, the plurality of second waveguides are separated from the plurality of first waveguides, and the first direction is perpendicular to the second direction. In an embodiment, the plurality of second waveguides and the plurality of first waveguides cross each other at intersection regions, and the first direction is perpendicular to the second direction. In an embodiment, the at least two of the plurality of EIC dies are coupled with each other through a first PIC die of the plurality of PIC dies, a corresponding first waveguide of the plurality of first waveguides, and a second PIC die of the plurality of PIC dies sequentially, and the at least two of the plurality of EIC dies are arranged at opposite edges of the array along the first direction. In an embodiment, the at least two of the plurality of EIC dies are coupled with each other through a third PIC die of the plurality of PIC dies, a corresponding second waveguide of the plurality of second waveguides, and a fourth PIC die of the plurality of PIC dies sequentially, and the at least two of the plurality of EIC dies are arranged at opposite edges of the array along the second direction. In an embodiment, the semiconductor structure further includes conductive wires on the waveguide layer, where the conductive wires are configured to electrically couple the plurality of processing dies with each other and each of the plurality of EIC dies with a corresponding edge processing die of the plurality of processing dies. In an embodiment, the semiconductor structure further includes a plurality of external photoelectric integrated circuit (PIC) dies on the substrate at the periphery of the array, where each of the plurality of external PIC dies is configured to couple a corresponding EIC die of the plurality of EIC dies with an external semiconductor structure.

Another embodiment of the disclosure is a semiconductor structure, which includes a substrate and a plurality of waveguides formed in the substrate. The semiconductor structure further includes a plurality of processing dies arranged in an array on the substrate and a plurality of electric integrated circuit (EIC) dies on the substrate at a periphery of the array, and electrically coupled with the plurality of processing dies, and a plurality of photoelectric integrated circuit (PIC) dies arranged at a periphery of the array and at edges of the substrate. At least two of the plurality of EIC dies arranged at opposite edges of the array are coupled to each other through the plurality of waveguides and the plurality of PIC dies.

Another embodiment of the disclosure is a method for manufacturing a semiconductor device. The method includes forming a substrate and forming a waveguide layer on the substrate, where the waveguide layer includes a plurality of waveguides. The method further includes arranging a plurality of processing dies in an array on the waveguide layer and arranging a plurality of electric integrated circuit (EIC) dies at a periphery of the array on the waveguide layer and electrically coupled with the plurality of processing dies. At least two of the plurality of EIC dies arranged at opposite edges of the array are coupled to each other through a corresponding waveguide of the plurality of waveguides

The foregoing outlines features of several embodiments or examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments or examples introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A semiconductor structure, comprising:
a substrate;
a waveguide layer formed on the substrate, wherein the waveguide layer includes a plurality of waveguides;
a plurality of processing dies arranged in an array on the waveguide layer; and
a plurality of electric integrated circuit (EIC) dies arranged at a periphery of the array on the waveguide layer and electrically coupled with the plurality of processing dies, wherein at least two of the plurality of EIC dies arranged at opposite edges of the array are coupled to each other through a corresponding waveguide of the plurality of waveguides.

2. The semiconductor structure according to claim 1, further comprising:
a plurality of photoelectric integrated circuit (PIC) dies, wherein each of the at least two of the plurality of EIC dies are coupled to the corresponding waveguide of the plurality of waveguides through a corresponding PIC die of the plurality of PIC dies.

3. The semiconductor structure according to claim 2, wherein:
the plurality of PIC dies are arranged on the substrate at the periphery of the array.

4. The semiconductor structure according to claim 1, wherein the plurality of waveguides include:
a plurality of first waveguides extending along a first direction; and
a plurality of second waveguides extending along a second direction,
wherein the first and second directions are different directions.

5. The semiconductor structure according to claim 4, wherein:
the plurality of second waveguides are formed over the plurality of first waveguides,
the plurality of second waveguides are separated from the plurality of first waveguides, and
the first direction is perpendicular to the second direction.

6. The semiconductor structure according to claim 4, wherein:
the plurality of second waveguides and the plurality of first waveguides cross each other at intersection regions, and
the first direction is perpendicular to the second direction.

7. The semiconductor structure according to claim 4, wherein:
the at least two of the plurality of EIC dies are coupled with each other through a first PIC die of the plurality of PIC dies, a corresponding first waveguide of the plurality of first waveguides, and a second PIC die of the plurality of PIC dies sequentially, and
the at least two of the plurality of EIC dies are arranged at opposite edges of the array along the first direction.

8. The semiconductor structure according to claim 4, wherein:
the at least two of the plurality of EIC dies are coupled with each other through a third PIC die of the plurality of PIC dies, a corresponding second waveguide of the plurality of second waveguides, and a fourth PIC die of the plurality of PIC dies sequentially, and
the at least two of the plurality of EIC dies are arranged at opposite edges of the array along the second direction.

9. The semiconductor structure according to claim 1, further comprising:
conductive wires on the waveguide layer, wherein the conductive wires are configured to electrically couple the plurality of processing dies with each other and each of the plurality of EIC dies with a corresponding edge processing die of the plurality of processing dies.

10. The semiconductor structure according to claim 1, further comprising:
a plurality of external photoelectric integrated circuit (PIC) dies on the substrate and arranged at the periphery of the array, wherein each of the plurality of external PIC dies is configured to couple a corresponding EIC die of the plurality of EIC dies with an external semiconductor structure.

11. A semiconductor structure, comprising:
a substrate;
a plurality of waveguides formed in the substrate;
a plurality of processing dies arranged in an array on the substrate;
a plurality of electric integrated circuit (EIC) dies on the substrate, arranged at a periphery of the array, and electrically coupled with the plurality of processing dies; and
a plurality of photoelectric integrated circuit (PIC) dies arranged at a periphery of the array and at edges of the substrate, wherein at least two of the plurality of EIC dies arranged at opposite edges of the array are coupled to each other through the plurality of waveguides and the plurality of PIC dies.

12. The semiconductor structure according to claim 11, wherein the plurality of waveguides include:
a plurality of first waveguides extending along a first direction; and
a plurality of second waveguides extending along a second direction,
wherein the first and second directions are different directions.

13. The semiconductor structure according to claim 12, wherein:
the plurality of second waveguides are formed over the plurality of first waveguides,
the plurality of second waveguides are separated from the plurality of first waveguides, and
the first direction is perpendicular to the second direction.

14. The semiconductor structure according to claim 12, wherein:
the plurality of second waveguides and the plurality of first waveguides cross each other at intersection regions, and
the first direction is perpendicular to the second direction.

15. The semiconductor structure according to claim 12, wherein:
the at least two of the plurality of EIC dies are coupled with each other through a first PIC die of the plurality of PIC dies, a corresponding first waveguide of the plurality of first waveguides, and a second PIC die of the plurality of PIC dies sequentially, and
the at least two of the plurality of EIC dies are arranged at opposite edges of the array along the first direction.

16. The semiconductor structure according to claim 12, wherein:
the at least two of the plurality of EIC dies are coupled with each other through a third PIC die of the plurality of PIC dies, a corresponding second waveguide of the plurality of second waveguides, and a fourth PIC die of the plurality of PIC dies sequentially, and
the at least two of the plurality of EIC dies are arranged at opposite edges of the array along the second direction.

17. The semiconductor structure according to claim 11, further comprising:
conductive wires in the substrate, wherein the conductive wires are configured to electrically couple the plurality of processing dies with each other and each of the plurality of EIC dies with a corresponding edge processing die of the plurality of processing dies.

18. A method for manufacturing a semiconductor structure, comprising:
forming a substrate;
forming a waveguide layer on the substrate, wherein the waveguide layer includes a plurality of waveguides;
arranging a plurality of processing dies arranged in an array on the waveguide layer; and
arranging a plurality of electric integrated circuit (EIC) dies at a periphery of the array on the waveguide layer and electrically coupled with the plurality of processing dies, wherein at least two of the plurality of EIC dies arranged at opposite edges of the array are coupled to each other through a corresponding waveguide of the plurality of waveguides.

19. The method according to claim 18, further comprising:
arranging a plurality of photoelectric integrated circuit (PIC) dies on the substrate and at the periphery of the array, wherein each of the at least two of the plurality of EIC dies are coupled to the corresponding waveguide of the plurality of waveguides through a corresponding PIC die of the plurality of PIC dies.

20. The method according to claim 19, further comprising:
disposing conductive wires on the waveguide layer, wherein the conductive wires are configured to electrically couple the plurality of processing dies with each other and each of the plurality of EIC dies with a corresponding edge processing die of the plurality of processing dies.
